(19) United States
(12) Patent Application Publication
(10) Pub. No.: US 2013/0322581 A1
(43) Pub. Date: Dec. 5, 2013

(54) Matched Filtered Data Samples Processing

(71) Applicants: Olli Juhani Piirainen, Oulu (FI); Markku Juha Vainikka, Kivinlemi (FI)

(72) Inventors: Olli Juhani Piirainen, Oulu (FI); Markku Juha Vainikka, Kivinlemi (FI)

(73) Assignee: Nokia Siemens Networks OY, Espoo (FI)

(21) Appl. No.: 13/980,357

(22) PCT Filed: Jan. 18, 2011
(86) PCT No.: PCT/EP11/00182

§ 371 Date: Aug. 16, 2013

(51) Int. Cl. H04L 7/04

(52) U.S. Cl. CPC H04L 7/042
USPC 375/343

(57) ABSTRACT

The invention relates to apparatuses, methods, a system, computer programs, computer program products and computer-readable media. Matched-filtered samples are conveyed instead of antenna samples, so that data rates in the interface between a remote radio head and the BTS or base band hotel may be lower. For detecting data, the matched filtered data samples are processed by using information on the radio channel.

### FIELD

The invention relates to apparatuses, methods, a system, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Modern multimedia devices enable providing users with more services. The usage of multimedia services increases the demand for rapid data transfer which in turn requires investments in radio networks. This has brought cost-effective technologies and network architectures, which also support sustainable development, into the beam of light.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: obtain at least one data sample; obtain information on a radio channel; matched filter the at least one data sample, and convey the at least one matched filtered data sample and the information on the radio channel to a remote processing unit the apparatus is operationally coupled to.

According to another aspect of the present invention, there is provided an apparatus comprising: at least one processor and at least one memory including a computer program code, the at least one memory and the computer program code configured to, with the at least one processor, cause the apparatus at least to: obtain at least one matched filtered data sample and information on a radio channel from a remote radio unit the apparatus is operationally coupled to; process the at least one matched filtered data sample by using the information on the radio channel for detecting data, and update at least one parameter used in the processing by using internal feedback information.

According to yet another aspect of the present invention, there is provided a method comprising: obtaining at least one data sample; obtaining information on a radio channel; matched filtering the at least one data sample, and conveying the at least one matched filtered data sample and the information on the radio channel to a remote processing unit.

According to yet another aspect of the present invention, there is provided a method comprising: obtaining at least one matched filtered data sample and information on a radio channel from a remote radio; processing the at least one matched filtered data sample by using the information on the radio channel for detecting data, and updating at least one parameter used in the processing by using internal feedback information.

According to yet another aspect of the present invention, there is provided an apparatus comprising: means for obtaining at least one data sample; means for obtaining information on a radio channel; means for matched filtering the at least one data sample, and means for conveying the at least one matched filtered data sample and the information on the radio channel to a remote processing unit. According to yet another aspect of the present invention, there is provided an apparatus comprising: means for obtaining at least one matched filtered data sample and information on a radio channel from a remote radio; means for processing the at least one matched filtered data sample by using the information on the radio channel for detecting data, and means for updating at least one parameter used in the processing by using internal feedback information.

According to yet another aspect of the present invention, there is provided a computer program embodied on a computer-readable storage medium, the computer program comprising program code for controlling a process to execute a process, the process comprising: obtaining at least one data sample; obtaining information on a radio channel; matched filtering the at least one data sample, and conveying the at least one matched filtered data sample and the information on the radio channel to a remote processing unit.

According to yet another aspect of the present invention, there is provided a computer program embodied on a computer-readable storage medium, the computer program comprising program code for controlling a process to execute a process, the process comprising: obtaining at least one matched filtered data sample and information on a radio channel from a remote radio; processing the at least one matched filtered data sample by using the information on the radio channel for detecting data, and updating at least one parameter used in the processing by using internal feedback information.

### LIST OF DRAWINGS

Some embodiments of the present invention are described below, by way of example only, with reference to the accompanying drawings, in which

FIGS. 1A and 1B illustrate examples of a system;

FIG. 2 is a flow chart;

FIG. 3 is another flow chart;

FIG. 4 illustrates examples of an apparatus, and

FIG. 5 illustrates examples of another apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

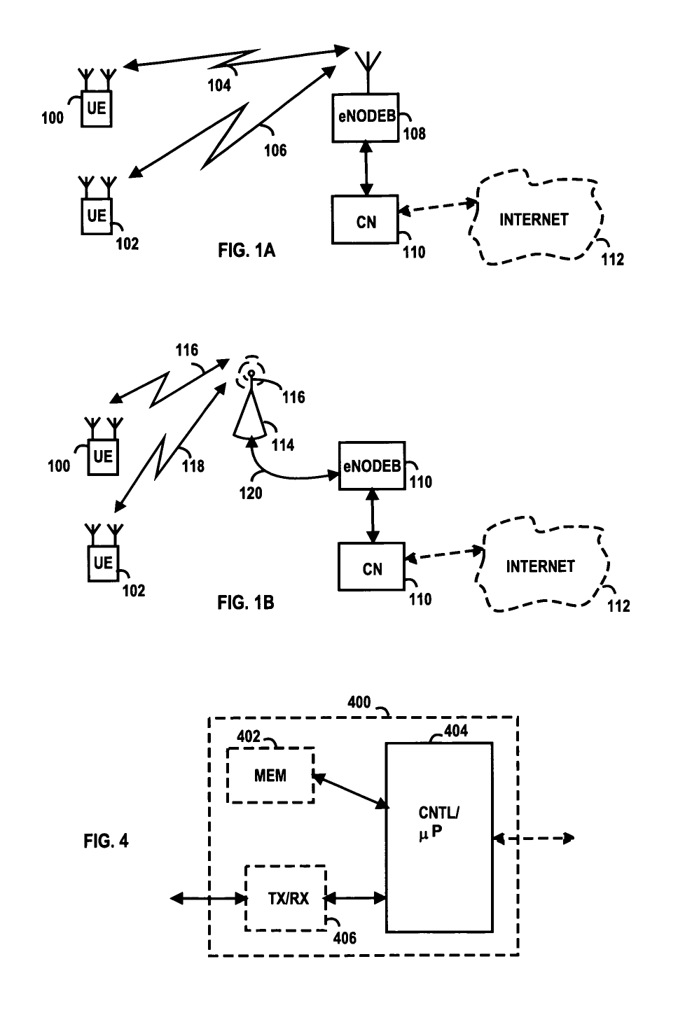

Typically, a (e)NodeB (“e” stands for advanced evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB. FIGS. 1A and 1B depict examples of simplified system architectures only showing some elements and functional entities, all being logical units, whose implementation may differ from what is shown. The connections shown in FIGS. 1A and 1B are logical connections; the actual physical connections may be different. It is apparent to a person skilled in the art that the system typically comprises also other functions and structures than those shown in FIGS. 1A and 1B.

The embodiments are not, however, restricted to the system given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

FIG. 1A shows a part of a radio access network of E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform. FIG. 1A shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for instance. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1A) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

Modern multimedia devices enable providing users with more services. The usage of multimedia services increases the demand for rapid data transfer which in turn requires investments in radio networks. Developed Networks enabling an adequate user experience when modern services and applications are used, typically means higher installation and operating expenses (OPEX). Further, as the power consumption of a base station typically maps directly into the operational expenses (OPEX) of a network operator, technologies enabling reduction of energy consumption of a network have been a focus of interest.

One means to be used in improving the usage of network resources in a cost-effective way is introducing remote radio frequency (RF) heads and base station hotels or base band hotels: the base station is split into two parts: a remote RF head and a baseband radio server typically coupled by a wired link (a wireless link is also possible). This produces a system wherein baseband radio servers may be deployed in an easy-to-access and/or low-cost location while remote radio frequency (RF) heads (RRHs) may be mounted on the rooftop close to an antenna. Usually, a remote RF head houses radio-related functions (transmitter RF, receiver RF, filtering etc.) and the base station part carries out other base station functions, such as base band functions. Each radio head may produce a separately controlled cell, but they may also constitute a cluster of cells with distributed antennas.

Further, multiple baseband radio servers may be placed in a same location, utilizing same resources, such as power supplies and backhaul connections, while RF heads may be distributed at locations providing desired radio coverage. This concept is supported by open base station architecture initiative (OBSAI) specifications. The concept of multiple remote RF heads coupled to a centralized base station may be referred as a base station (BTS) hotel. Base station hotels or base band hotels with extensive integration and joint processing are also referred to as cloud RAN (C-RAN).

One advantage of the base station (BTS) or base band hotel architecture lies in its ability to provide cost-effective BTS redundancy.

FIG. 1B shows an example how the base station (BTS) or base band hotel concept may be implemented in the system of FIG. 1A. Similar reference numbers refer to similar units, elements, connections etc. Only differences between FIGS. 1A and 1B are explained in this context.

The base station (BTS) or base band hotel concept is taken herein only as an example. However, embodiments are not restricted to this concept. For example, the embodiments are applicable to networks, wherein nodes are coupled with optical fibre.

In FIG. 1B, a radio head 114 is placed near antenna 116 and the rest of the base station (in this example eNodeB) 110 is located in a centralized position which may be suitable for multiple base stations. In this example, the link between the radio head 114 and the base station 110 is implemented with an optical fibre connection 120.

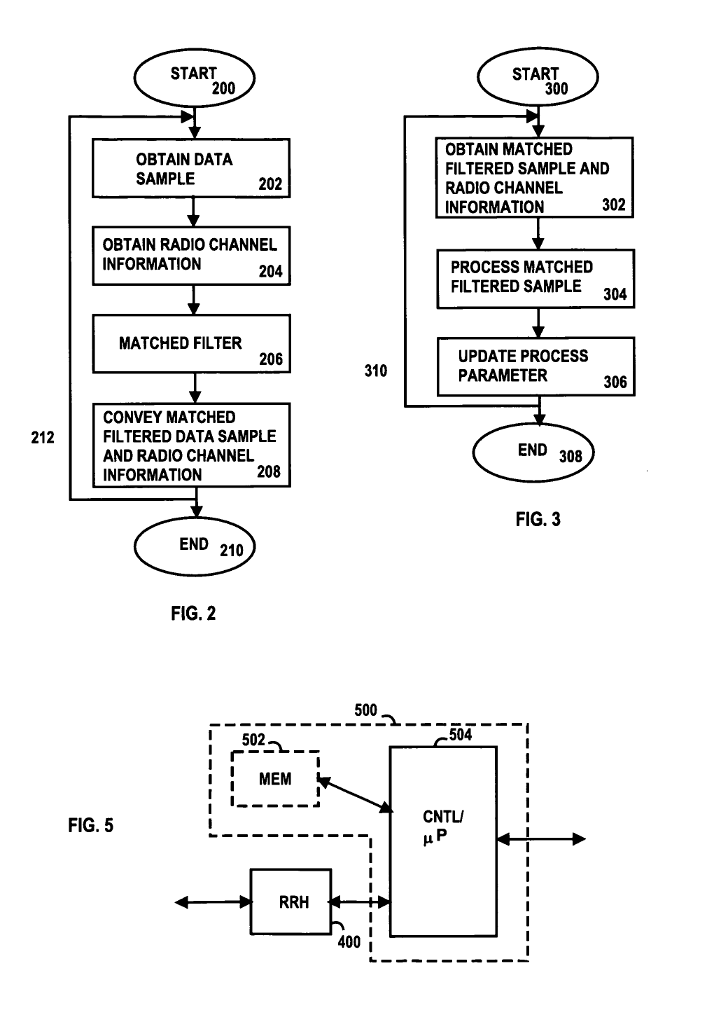

In the following, some embodiments are disclosed in further details in relation to FIG. 2. The embodiment of FIG. 2 is usually related to a remote radio unit operationally coupled to a base station, node, host, server etc provided with required functionality to carry out base station and/or radio network controller functionalities (excluding radio functionalities).

Usually, signal samples after digital front-end are transmitted over the interface between a remote radio head and a central processing unit of a base band or BTS hotel. That requires a plenty of capacity in the transmission path as well as in the central processing unit. A remote radio head and its central processing unit may locate at a distance from each other. Then, usually, costs play an important role and the reduction of a required data rate is an issue of interest. Additionally, scalability of a system may be improved, since reduced data rates on connections and a lower processing load in a central processing unit enable controlling of increased number of radio heads by the central unit.

The embodiment starts in block 200.

In block 202, at least one data sample is obtained. The samples are typically obtained by sampling a received signal. Embodiments do not limit the selection of a sampling method, but leaves it open. Thus, the sampling methods are not explained herein in further detail. Typically, the suitable methods are dependent on current radio protocol.

In block 204, information on a radio channel is obtained. Usually, the information on a radio channel may include measurement information on quality, determination of bit error rates, determination of channel impulse response, determination of channel matrix, etc. Embodiments do not set conditions for the suitableness of channel information. Hence, the obtaining information on a radio channel is not explained herein in further detail.

In block 206, the at least one data sample is matched filtered.

Typically, a radio communication system is a linear time variant system of a nature. Thus, a receiver needs to adjust itself to the changes in the radio channel during the reception.

A matched filter is an optimal linear filter for maximizing signal-to-noise ratio (SNR) in the presence of additive stochastic noise typically used in a receiver. Theoretically, the signal-to-noise ratio is maximized when the impulse response of the filter is a reversed and time delayed copy of a transmitted signal. Matched filtering is used to detect a known signal or wavelet in a noisy received signal or wavelet. Typically, a matched filter is “matched” to the pulse shape of a transmitted signal for filtering out frequencies that are outside the desired frequency band thus limiting noise spectrum.

In block 208, the at least one matched filtered data sample and the information on the radio channel are conveyed to a remote processing unit the apparatus is operationally coupled to.

The conveyance may be carried out by transmitting by a fixed line, such as an optical fibre or wirelessly. The wireless or wired transmission may be carried out in a frequency domain for simplifying signal processing. They may also be carried out in a time domain.

The processing unit may take care of base band processing which typically means digital signal processing required for signal detection. In the LTE, turbo equalization may be used. In the following exemplifying equations, it is assumed that turbo equalization is used. However, turbo equalization is only one design option and not mandatory. The successful reception of a signal in a digital communications system typically requires adaptation of signal processing algorithms before a receiver is able to detect meaningful data. The adaptation usually needs processing of a plurality of received symbols. Thus, these algorithms utilize one or more feedback loops.

Transmitting a signal through a multipath radio channel usually results in a received signal consisting of delayed and scaled versions of the originally transmitted signal. A channel equalizer is an adaptive filter that is designed to remove intersymbol interference caused by the multipath effect. Many different kinds of channel equalizer exists, one example is a minimum mean square error (MMSE) equalizer. In theory, channel equalizers are designed to minimize the variance of the difference between transmitted data and the signal the equalizer outputs. A channel equalizer is usually adapted to changes in a radio path by using feedback information obtained from signal detection.

The basic principle of turbo codes is the use of a plurality (typically two) of encoders/decoders and likelihood data to reconcile differences between estimates generated by these encoders/decoders. In a receiver, each of the convolutional decoders generates an estimate of received bits or symbols and likelihood information. The estimates are compared, and if they differ, the decoders exchange the likelihood information on their estimates. The likelihood from the other decoder is used to generate a new estimate, etc. The iterative process continues until the decoders arrive at the same estimate.

When MMSE is used, a transmitted symbol x is considered to be Gaussian distributed and it may be expressed as:

x=E(x)+(H^{H}H+σ²Rₓ⁻¹)⁻¹(H^{H}y−H^{H}HE(x)), (1)

wherein
E(x) denotes an expected value of x,
H denotes a channel matrix,
H^{H} denotes Hermitian transformation of a channel matrix,
σ² denotes variance of zero-mean uncorrelated white noise,
Rₓ⁻¹ denotes an inverted correlation matrix, and
y denotes a received signal.

For the Equation (1) it is assumed that a signal model is as follows:

y=Hx+w, (2)

wherein
y denotes a received signal,
H denotes a channel matrix,
x denotes a transmitted symbol, and
w denotes zero-mean uncorrelated white noise.

It can be seen that in turbo equalization/decoding, additional information regarding modulation and channel coding is typically fed back as improved expected value of x and correlation matrix Rₓ.

During processing, it is not necessary to update terms H and H^{H}H at all or they may be updated seldomly. It should be appreciated that term H^{H}y is the output of a matched filter and it is “new data” which usually is transmitted at a symbol rate. Thus, feedback may be carried out inside a base band unit.

The previous result may also be extended to other equalizers (thus not only to MMSE) and/or receiver structures, for example by using Ungerboeck metric. A generalized receiver may calculate a metric:

L(x)=x^{H}H^{H}H^{H}y−x^{H}H^{H}Hx, (3)

wherein
L(x) denotes a metric which is designed to maximize the likelihood of received sequence x,
x denotes a transmitted symbol,
x^{H} denotes a Hermitian transformation of a transmitted symbol,
H denotes a channel matrix,
H^{H} denotes Hermitian transformation of a channel matrix,
y denotes a received signal

Conveyed symbols may be, in the case an LTE MMSE equalization is used, H^{H}H and H^{H}y in other words matched filter output and a channel estimate. Any equivalent information on a radio channel, such as singular values of a correlation matrix may be another option for channel information. If matched-filtered samples are conveyed instead of antenna samples, data rates in the interface between a remote radio head and the BTS or base band hotel may be lower due to a lower word length of intermediate processing results compared with “raw” antenna samples. Further savings in the amount of data to be conveyed may be attained for data in a frequency domain representation by omitting pilot symbols and data samples of frequency band gaps. Moreover, diversity antenna branches may be combined or summed to a single stream. Besides, interface rate may be scaled according to capacity needs, it needn't to be fixed by a current bandwidth. Fast-Fourier Transformation (FFT) calculation and channel estimation processing load may be distributed between remote radio heads s and a BTS or base band hotel. On top of that, the FFT may be carried out antenna-wise. Channel estimation results may be used also for downlink transmission. Additionally, RRHs may take care of frequency offset estimation and/or correction as well as of interference cancellation. Remote radio heads (under the control of a same central processing unit or a cluster of central processing units capable to communicate with each other) may also share the processing load of each other. For example, if one radio head is overloaded, another one may carry out part of its duties or if one radio head has a low processing load, it may request load from other radio heads, or different tasks may be dealt with different radio heads, etc. On the other hand, since the processing results (typically at least partly completed) of a plurality of radio heads may be combined or aggregated (even to a single stream), connections between different units of a system do not necessarily have to be scaled with the number of remote radio heads in the system.

The embodiment ends in block 210. The embodiment is repeatable in many ways. One example is shown by arrow 212 in FIG. 2.

In the following, some other embodiments are disclosed in further details in relation to FIG. 3. The embodiment of FIG. 3 is usually related to a base station, node, host, server etc provided with required functionality to carry out base station and/or radio network controller functionalities excluding radio functionalities. The base station, node, host, server etc. may thus be operationally coupled to a remote radio unit. The embodiments are especially suitable to be carried out by a centralised network controller which may be located in a node device, host or server, or a node device, host or server may be coupled to it. The centralised network controller may be placed in the same premises or nearby and be coupled to nodes providing base station and/or network controlling functionalities.

Usually, signal samples after digital front-end are transmitted over the interface between a remote radio head and a central processing unit of a base band or BTS hotel. That requires a plenty of capacity in the transmission path as well as in the central processing unit. A remote radio head and its central processing unit may locate at a distance from each other. Then, usually, costs play an important role and the reduction of a required data rate is an issue of interest.

The embodiment starts in block 300.

In block 302, at least one matched filtered data sample and information on a radio channel are obtained from a remote radio unit the apparatus is operationally coupled to. The remote radio unit may be a remote radio head (RRH) of a base band or base station hotel concept.

The at least one matched filtered data sample and information on a radio channel may be obtained by receiving data by a fixed line, such as an optical fibre or wirelessly. The wireless or wired transmission may be carried out in a frequency domain. They may also be carried out in a time domain.

The information on the radio channel may include measurement information on quality, determination of bit error rates, determination of channel impulse response, etc. Embodiments do not set conditions for the suitableness of typically used channel information. Hence, obtaining information on a radio channel is not explained herein in further detail.

Matched filtering is explained shortly above.

In block 304, the at least one matched filtered data sample is processed by using the information on the radio channel for detecting data.

The processing may be digital signal processing and include channel equalization and decoding, such as turbo decoding. Digital signal processing may include a plurality of different process phases typically implemented as different algorithms. These algorithms are not the core of embodiments and a skilled person in the art may choose them according to current needs without limitations set by the embodiments. Hence, these algorithms are not thoroughly explained herein.

As an example, in the LTE, MMSE-equalization may be carried out in the frequency domain starting from Equation (1) as follows:

$$\begin{matrix}x = E ( x ) + {( {H}^{H} H + {σ}^{2} {R}_{x}^{- 1} )}^{- 1} ( {H}^{H} y - {H}^{H} H E ( x ) ) \\ = E ( x ) + {{F}^{H} ( Λ + {σ}^{2} {R}_{x}^{- 1} )}^{- 1} ( {Σ}^{H} F y - Λ F E ( x ) ) ,\end{matrix} \qquad ( 4 )$$

wherein
E(x) denotes an expected value of x,
H denotes a channel matrix,
H^{H} denotes a Hermitian transformation of a channel matrix,
σ² denotes variance of zero-mean uncorrelated white noise,
Rₓ⁻¹ denotes an inverted correlation matrix,
y denotes a received signal,
F denotes a Fourier matrix replaceable by Fast Fourier Transform/Discrete Fourier Transform,
F^{H} denotes Hermitian transformation of a Fourier matrix,
Λ denotes eigenvalues of H^{H}H
Σ denotes singular values of H

In this example, the information on the radio channel comprises a correlation matrix Rₓ and a channel matrix H. Turbo decoding is shortly outlined above.

In block 306, at least one parameter used in the processing is updated by using internal feedback information.

In turbo decoding/equalization, additional information regarding modulation and channel coding is typically fed back as improved expected value of x and correlation matrix Rₓ.

It is not necessary to update term H^{H}H (or another corresponding parameter) at all or it may be updated seldomly. H^{H}y is the output of a matched filter and its data rate is lower than that of a received data y. Thus, a feedback loop may be inside a base band unit. The result may also be extended to other equalizers than an MMSE and/or receiver structures using Ungerboeck metric.

The embodiment ends in block 308. The embodiment is repeatable in many ways. One example is shown by arrow 310 in FIG. 3.

The steps/points, signaling messages and related functions described above in FIGS. 2 and 3 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message to be transmitted and/or received, or physical transmission and/or reception itself, etc on a case by case basis.

An embodiment provides an apparatus which may be any remote radio unit, such a remote radio head, or any other suitable apparatus able to carry our processes described above in relation to FIG. 2.

FIG. 4 illustrates a simplified block diagram of an apparatus according to an embodiment especially suitable for operating as a remote radio head.

As an example of an apparatus according to an embodiment, it is shown an apparatus 400, such as a node device, host or server, including facilities in a control unit 404 (including one or more processors, for example) to carry out functions of embodiments, such as matched filtering signal samples. This is depicted in FIG. 4. As an embodiment, the control unit/microprocessor 404 may include a digital front-end and a matched filter. The control unit/microprocessor 404 may also include other parts/units/modules depending on the current implementation as explained above in relation to FIG. 2. Block 406 includes parts/units/modules need for reception and transmission, usually called a radio front end, RF-parts, radio parts, etc. The apparatus may include wired or wireless connection to a central processing unit or a corresponding device, unit or module for data conveyance as well. Since a plurality of apparatuses may be in cooperation with each other, the apparatus may also be configured to convey and/or process data for mutual communication. Data processing typically carried out by a control unit 404 may also comprise combination or aggregation of data from a plurality of apparatuses.

Another example of an apparatus 400 may include at least one processor 404 and at least one memory 402 including a computer program code, the at least one memory and the computer program code configured to, with the at least one processor, cause the apparatus at least to: obtain at least one data sample, obtain information on a radio channel, matched filter the at least one data sample, and convey the at least one matched filtered data sample and the information on the radio channel to a remote processing unit the apparatus is operationally coupled to. The apparatus may also include radio parts 406. The apparatus may include wired or wireless connection to a central processing unit or a corresponding device, unit or module for data conveyance as well. Since a plurality of apparatuses may be in cooperation with each other, the apparatus may also be configured to convey and/or process data for mutual communication. Data processing typically carried out by a processor 404 may also comprise combination or aggregation of data from a plurality of apparatuses.

Yet another example of an apparatus comprises means 402, 404, (406) for obtaining at least one data sample, means 402, 404, (406) for obtaining information on a radio channel, means 402, 404 for matched filtering the at least one data sample, and means 402, 404, (406) for conveying the at least one matched filtered data sample and the information on the radio channel to a remote processing unit the apparatus is operationally coupled to. The apparatus may also include means for reception and transmission 406. The apparatus may include wired or wireless connection to a central processing unit or a corresponding device, unit or module for data conveyance as well. Since a plurality of apparatuses may be in cooperation with each other, the apparatus may also include means for conveying and/or processing data for mutual communication. Data processing typically carried out by means 404 may also comprise combination or aggregation of data from a plurality of apparatuses.

Yet another example of an apparatus comprises a first obtainer configured to obtain at least one data sample, a second obtainer configured to obtain information on a radio channel, a filter configured to matched filter the at least one data sample, and a conveying unit configured to convey the at least one matched filtered data sample and the information on the radio channel to a remote processing unit the apparatus is operationally coupled to. The apparatus may also include a radio unit 406. The apparatus may include wired or wireless connection to a central processing unit or a corresponding device, unit or module for data conveyance as well. Since a plurality of apparatuses may be in cooperation with each other, the apparatus may also be configured to convey and/or process data for mutual communication. Data processing may also comprise combination or aggregation of data from a plurality of apparatuses.

Another embodiment provides an apparatus which may be any node, host, server or any other suitable apparatus able to carry out processes described above in relation to FIG. 5.

FIG. 5 illustrates a simplified block diagram of an apparatus according to an embodiment especially suitable for operating as a node, host or server. The apparatus is suitable for controlling radio heads producing radio cells. The apparatus may include or be located in a centralised network controller which may be situated in the node, host or server or be coupled to it. The apparatus is suitable for the BTS or base band hotel concept.

An embodiment of a method which may be carried out in a node, host or server is described above in relation to FIG. 3.

As an example of an apparatus according to an embodiment, it is shown an apparatus 500, such as a node device, host or server, including facilities in a control unit 504 (including one or more processors, for example) to carry out functions of embodiments, such as suitable parts of digital signal processing. This is depicted in FIG. 5. As an embodiment, the control unit/microprocessor 504 may include a channel equalizer, deinterleaver and/or descrambler and turbo decoder. The control unit/microprocessor 504 may differ from this embodiment depending on the current implementation as explained above in relation to FIG. 3.

Another example of an apparatus 500 may include at least one processor 504 and at least one memory 502 including a computer program code, the at least one memory and the computer program code configured to, with the at least one processor, cause the apparatus at least to: obtain at least one matched filtered data sample and information on a radio channel from a remote radio unit the apparatus is operationally coupled to, process the at least one matched filtered data sample by using the information on the radio channel for detecting data, and update at least one parameter used in the processing by using internal feedback information.

Yet another example of an apparatus comprises means 502, 504, for obtaining at least one matched filtered data sample and information on a radio channel from a remote radio unit the apparatus is operationally coupled to, means 502, 504 for processing the at least one matched filtered data sample by using the information on the radio channel for detecting data, and means 504 for updating at least one parameter used in the processing by using internal feedback information.

Yet another example of an apparatus comprises an obtainer configured to obtain at least one matched filtered data sample and information on a radio channel from a remote radio unit the apparatus is operationally coupled to, a processing unit configured to process the at least one matched filtered data sample by using the information on the radio channel for detecting data, and un updating unit configured to update at least one parameter used in the processing by using internal feedback information.

It should be understood that the apparatuses may include or be coupled to other units or modules etc, such as radio heads, used in or for transmission/reception. An example of a radio head is depicted in FIG. 4 by using reference number 400. The connection between a radio head and the apparatus is typically implemented as a wired link, such as an optical fibre.

Although the apparatuses have been depicted as one entity in FIGS. 4 and 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be down-loaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above.

Other embodiments provide computer programs embodied on a computer readable medium, configured to control a processor to perform embodiments of the methods described above. The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
obtain at least one data sample;
obtain information on a radio channel;
matched filter the at least one data sample, and
convey the at least one matched filtered data sample and the information on the radio channel to a remote processing unit the apparatus is operationally coupled to.

2. The apparatus of claim 1, wherein the at least one matched filtered data sample and the information on the radio channel are conveyed wirelessly or by a fixed line in a frequency domain representation or in a time domain representation.

3. The apparatus of claim 1, wherein signals from diversity antenna branches are combined to a single stream.

4. The apparatus of claim 1, wherein data from different remote radio units is combined or aggregated.

5. The apparatus of claim 1, further configured to:
calculate Fast-Fourier Transformation, and
carry out channel estimation.

6. The apparatus of claim 1, further configured to carry out at least one of the following: frequency offset estimation, frequency correction and interference cancellation.

7. The apparatus of claim 1, wherein the apparatus and the remote processing unit the apparatus is operationally coupled to, locate at a distance from each other.

8. The apparatus of claim 1, the apparatus comprising a remote radio head of a base band or base station hotel concept.

9. (canceled)

10. An apparatus comprising:
at least one processor and at least one memory including a computer program code, the at least one memory and the computer program code configured to, with the at least one processor, cause the apparatus at least to:
obtain at least one matched filtered data sample and information on a radio channel from a remote radio unit the apparatus is operationally coupled to;
process the at least one matched filtered data sample by using the information on the radio channel for detecting data, and
update at least one parameter used in the processing by using internal feedback information.

11. The apparatus of claim 10, wherein the remote radio unit is a remote radio head (RRH) of a base band or base station hotel concept.

12. The apparatus of claim 10, wherein the at least one matched filtered data sample and the information on the radio channel are conveyed wirelessly or by a fixed line in a frequency domain or in a time domain.

13.-15. (canceled)

16. A method comprising:
obtaining at least one data sample;
obtaining information on a radio channel;
matched filtering the at least one data sample, and
conveying the at least one matched filtered data sample and the information on the radio channel to a remote processing unit.

17.-22. (canceled)

23. A method comprising:
obtaining at least one matched filtered data sample and information on a radio channel from a remote radio;
processing the at least one matched filtered data sample by using the information on the radio channel for detecting data, and
updating at least one parameter used in the processing by using internal feedback information.

24.-28. (canceled)

29. A computer program embodied on a computer-readable storage medium, the computer program comprising program code for controlling a process to execute a process, the process comprising:
obtaining at least one data sample;
obtaining information on a radio channel;
matched filtering the at least one data sample, and
conveying the at least one matched filtered data sample and the information on the radio channel to a remote processing unit.

30. A computer program embodied on a computer-readable storage medium, the computer program comprising program code for controlling a process to execute a process, the process comprising:
obtaining at least one matched filtered data sample and information on a radio channel from a remote radio;
processing the at least one matched filtered data sample by using the information on the radio channel for detecting data, and
updating at least one parameter used in the processing by using internal feedback information.
